(19) United States
(12) Patent Application Publication
(10) Pub. No.: US 2020/0264883 A1
(43) Pub. Date: Aug. 20, 2020

(54) LOAD/STORE BYTES REVERSED ELEMENTS INSTRUCTIONS

(71) Applicant: INTERNATIONAL BUSINESS MACHINES CORPORATION, Armonk, NY (US)

(72) Inventors: Cedric Lichtenau, Stuttgart (DE); Jonathan D. Bradbury, Poughkeepsie, NY (US); Razvan Peter Figuli, Remchingen (DE); Gregory Miaskovsky, Ariel (IL)

(21) Appl. No.: 16/279,263

(22) Filed: Feb. 19, 2019

(51) Int. Cl. G06F 9/30

(52) U.S. Cl. CPC G06F 9/30185; G06F 9/30018

(57) ABSTRACT

A single architected instruction to perform a data reversal operation is executed. The executing includes obtaining input data and a modifier control of the instruction. The modifier control has one value of a plurality of values defined for the instruction and indicates an element size. The data reversal operation is performed on the input data. The performing includes placing, in a selected location, an element of the input data, the element having the element size indicated by the modifier control; reversing an order of the input data in the element; and repeating the placing and the reversing, based on the input data having one or more other elements to be processed. The output of the performing includes one or more elements of data that include output data in a reversed order from the input data of the corresponding one or more elements.

### BACKGROUND

One or more aspects relate, in general, to facilitating processing within a computing environment, and in particular, to facilitating processing associated with loading and storing data.

Data may be transmitted or stored in memory in various data formats, including in a little-endian format or a big-endian format. In the little-endian format, the least significant byte of an element or operand is first (e.g., lowest address of the element byte or operand byte) and the most significant byte is last (e.g., highest address of the element byte or operand byte). However, in the big-endian format, the most significant byte is first, and the least significant byte is last.

Computing environments are defined to use a particular format, such as little endian or big endian. For instance, the x86 computing architecture is defined to use the little-endian format, and thez/Architecture® hardware architecture, offered by International Business Machines Corporation, Armonk, N.Y., is defined to use the big-endian format. Therefore, if a system based on the z/Architecture hardware architecture is to use data from a system that uses the little-endian format, the data is to be converted to the big-endian format. The converted data is processed and then converted back to its original format. This is expensive in terms of time and performance overhead.

To perform the conversion, in one example, a permute instruction may be placed after each load instruction or before each store instruction to change the data format of the loaded or stored data, adding overhead for the load and store operations. In another example, source code may be rewritten to provide the desired format.

### SUMMARY

Shortcomings of the prior art are overcome, and additional advantages are provided through the provision of a computer program product for facilitating processing within a computing environment. The computer program product includes a computer readable storage medium readable by a processing circuit and storing instructions for performing a method. The method includes executing an instruction to perform a data reversal operation. The instruction is a single architected instruction. The executing includes obtaining input data on which the data reversal operation is to be performed and obtaining a modifier control of the instruction. The modifier control has one value of a plurality of values defined for the instruction and indicates an element size. The data reversal operation is performed on the input data. The performing includes placing, in a selected location, an element of the input data, the element having the element size indicated by the modifier control; reversing an order of the input data in the element; and repeating the placing and the reversing, based on the input data having one or more other elements to be processed. An output of the performing includes one or more elements of data that include output data in a reversed order from the input data of the corresponding one or more elements.

By using a single architected instruction to place the data and permute the data, instead of separate instructions to perform the placing and permuting, execution time is decreased, and performance is improved. Further, by using a single architected instruction having a selectable element size, processing within the computing environment is facilitated. The number of instructions to be defined and implemented is reduced, as well as complexity of the architecture. Memory is also saved.

In one embodiment, the data reversal operation is a load data reversal operation and the element of the input data is obtained from a memory location. The memory location is determined, for instance, using one or more fields of the instruction, and the selected location is specified using one or more other fields of the instruction. As an example, the modifier control is an input to the instruction specifying the element size of one or more elements of the input data to be loaded from memory to the selected location.

By using a single architected instruction to perform the load operation and the data reversal operation, instead of separate instructions to perform the two operations, execution time is decreased, and performance is improved.

In another embodiment, the data reversal operation is a store data reversal operation, the selected location in which the element is placed is a memory location, and the element of the input data is obtained from another selected location. The other selected location is specified, for instance, using one or more fields of the instruction, and the memory location is determined using one or more other fields of the instruction. As an example, the modifier control is an input to the instruction specifying the element size of one or more elements of the input data to be stored into memory.

By using a single architected instruction to perform the store operation and the data reversal operation, instead of separate instructions to perform the two operations, execution time is decreased, and performance is improved.

In one example, the modifier control is an input to the instruction, and the plurality of values includes a first value indicating the element size is a halfword, a second value indicating the element size is a word, and a third value indicating the element size is a doubleword. In a further example, the plurality of values includes a fourth value indicating the element size is a quadword. As a particular example, the modifier control is included in a mask field of the instruction.

As an example, the instruction includes at least one operation code field to provide an operation code indicating an operation to be performed; a register field and a register extension field to be used to specify a register to be used by the instruction; an index register field, a base field and a displacement field used to determine an address to be used by the instruction; and a mask field including the modifier control.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to incorporate and use one or more aspects of the present invention;

FIG. 1B depicts further details of a processor of FIG. 1A, in accordance with one or more aspects of the present invention;

FIG. 2 depicts another example of a computing environment to incorporate and use one or more aspects of the present invention;

FIG. 3A depicts one example of a Vector Load Byte Reversed Elements instruction, in accordance with an aspect of the present invention;

FIG. 3B depicts examples of resulting byte positions based on executing the Vector Load Byte Reversed Elements instruction, in accordance with an aspect of the present invention;

FIG. 4A depicts one example of a Vector Load Elements Reversed instruction, in accordance with an aspect of the present invention;

FIG. 4B depicts examples of resulting byte positions based on executing the Vector Load Elements Reversed instruction, in accordance with an aspect of the present invention;

FIG. 5A depicts one example of a Vector Store Byte Reversed Elements instruction, in accordance with an aspect of the present invention;

FIG. 5B depicts examples of resulting byte positions based on executing the Vector Store Byte Reversed Elements instruction, in accordance with an aspect of the present invention;

FIG. 6A depicts one example of a Vector Store Elements Reversed instruction, in accordance with an aspect of the present invention;

FIG. 6B depicts examples of resulting byte positions based on executing the Vector Store Elements Reversed instruction, in accordance with an aspect of the present invention;

FIG. 7 depicts one example of executing an instruction to place data in a selected location and to reverse the data, in accordance with an aspect of the present invention;

FIG. 8 depicts one example of processing associated with executing the load instructions of FIGS. 3A and 4A, in accordance with one or more aspects of the present invention;

FIG. 9 depicts one example of processing associated with executing the store instructions of FIGS. 5A and 6A, in accordance with one or more aspects of the present invention;

FIGS. 10A-10B depict one example of facilitating processing within a computing environment, in accordance with an aspect of the present invention;

FIG. 11A depicts another example of a computing environment to incorporate and use one or more aspects of the present invention;

FIG. 11B depicts further details of the memory of FIG. 11A;

FIG. 12 depicts one embodiment of a cloud computing environment; and

FIG. 13 depicts one example of abstraction model layers.

### DETAILED DESCRIPTION

In accordance with an aspect of the present invention, a capability is provided to facilitate processing within a computing environment. In one example, the capability includes reversing the order of data during a load or a store operation. For instance, bytes (or other data units) within a data element are reversed or data elements themselves are reversed. This may occur while loading data from memory or storing data to memory. By reversing the order of data, certain operations are facilitated, including, but not limited to, converting endianness. Endianness conversion is used, for instance, in machine learning or other tasks that use models to be executed on different machines having different endianness. By converting the endianness, processing is facilitated, and performance is improved.

As one example, the capability includes architected instructions to perform, as part of execution of a single architected instruction, the load/store operation and the data reversal (referred to herein as load and/or store reversed processing). For example, a Vector Load Byte Reversed Elements instruction, a Vector Load Elements Reversed instruction, a Vector Store Byte Reversed Elements instruction and a Vector Store Elements Reversed instruction are provided. Each instruction is part of an instruction set architecture (ISA). For instance, each instruction is a single architected machine instruction (e.g., hardware instruction) at the hardware/software interface. Each instruction is part of a general-purpose processor instruction set architecture (ISA), which is dispatched by a program (e.g., a user program, operating system or other program) on a processor, such as a general-purpose processor.

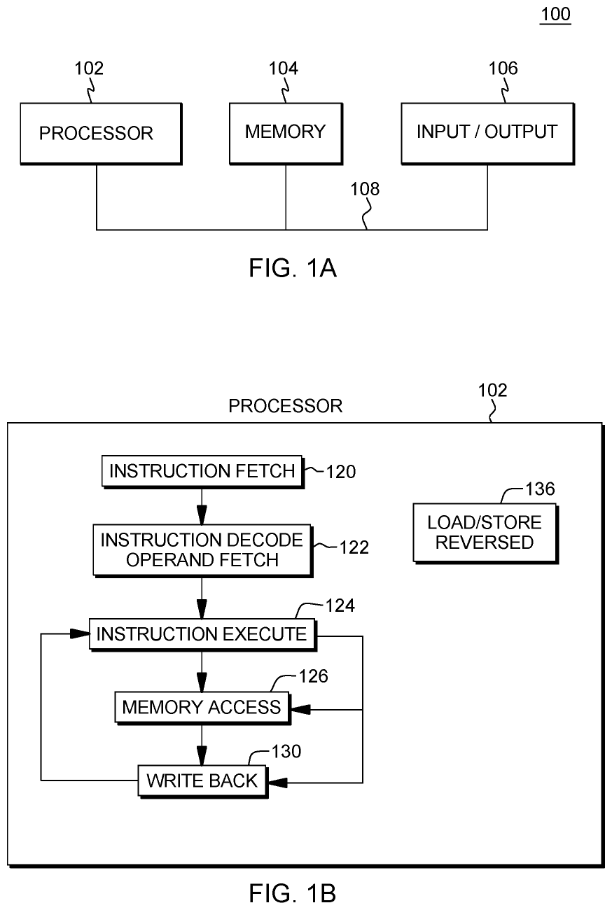

One embodiment of a computing environment to incorporate and use one or more aspects of the present invention is described with reference to FIG. 1A. A computing environment 100 includes, for instance, a processor 102 (e.g., a central processing unit), a memory 104 (e.g., main memory; a.k.a., system memory, main storage, central storage, storage), and one or more input/output (I/O) devices and/or interfaces 106 coupled to one another via, for example, one or more buses 108 and/or other connections.

In one example, processor 102 is based on the z/Architecture hardware architecture offered by International Business Machines Corporation, Armonk, N.Y., and is part of a server, such as an IBM Z® server, which is also offered by International Business Machines Corporation and implements the z/Architecture hardware architecture. One embodiment of the z/Architecture hardware architecture is described in a publication entitled, “z/Architecture Principles of Operation,” IBM Publication No. SA22-7832-11, 12^{th} edition, September 2017, which is hereby incorporated herein by reference in its entirety. The z/Architecture hardware architecture, however, is only one example architecture; other architectures and/or other types of computing environments may include and/or use one or more aspects of the present invention. In one example, the processor executes an operating system, such as the z/OS® operating system, also offered by International Business Machines Corporation.

Processor 102 includes a plurality of functional components used to execute instructions. As depicted in FIG. 1B, these functional components include, for instance, an instruction fetch component 120 to fetch instructions to be executed; an instruction decode unit 122 to decode the fetched instructions and to obtain operands of the decoded instructions; an instruction execute component 124 to execute the decoded instructions; a memory access component 126 to access memory for instruction execution, if necessary; and a write back component 130 to provide the results of the executed instructions. One or more of these components may, in accordance with one or more aspects of the present invention, include at least a portion of or have access to one or more other components used in load and/or store reversed processing, as described herein. The one or more other components include, for instance, a load/store reversed component 136.

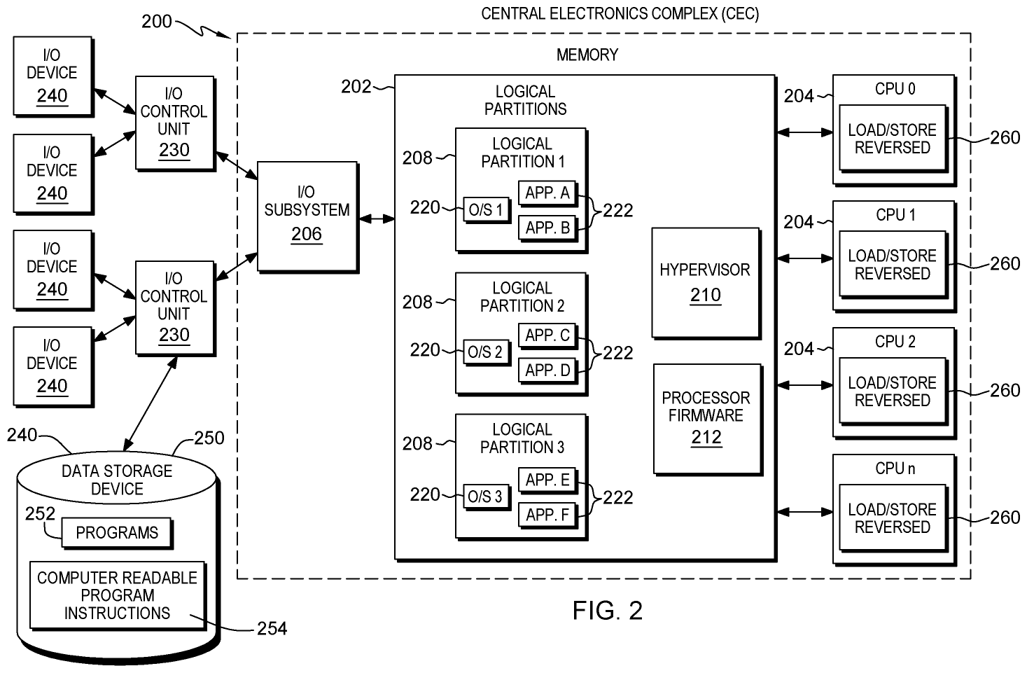

Another example of a computing environment to incorporate and use one or more aspects of the present invention is described with reference to FIG. 2. In one example, the computing environment is based on the z/Architecture hardware architecture; however, the computing environment may be based on other architectures offered by International Business Machines Corporation or others.

Referring to FIG. 2, in one example, the computing environment includes a central electronics complex (CEC) 200. CEC 200 includes a plurality of components, such as, for instance, a memory 202 (a.k.a., system memory, main memory, main storage, central storage, storage) coupled to one or more processors (a.k.a., central processing units (CPUs)) 204, and to an input/output subsystem 206.

Memory 202 includes, for example, one or more logical partitions 208, a hypervisor 210 that manages the logical partitions, and processor firmware 212. One example of hypervisor 210 is the Processor Resource/System Manager (PR/SM™) hypervisor, offered by International Business Machines Corporation, Armonk, N.Y. As used herein, firmware includes, e.g., the microcode of the processor. It includes, for instance, the hardware-level instructions and/or data structures used in implementation of higher level machine code. In one embodiment, it includes, for instance, proprietary code that is typically delivered as microcode that includes trusted software or microcode specific to the underlying hardware and controls operating system access to the system hardware.

Each logical partition 208 is capable of functioning as a separate system. That is, each logical partition can be independently reset, run a guest operating system 220 such as the z/OS operating system, or another operating system, and operate with different programs 222. An operating system or application program running in a logical partition appears to have access to a full and complete system, but in reality, only a portion of it is available.

Memory 202 is coupled to processors (e.g., CPUs) 204, which are physical processor resources that may be allocated to the logical partitions. For instance, a logical partition 208 includes one or more logical processors, each of which represents all or a share of a physical processor resource 204 that may be dynamically allocated to the logical partition. In one example, processor 204 includes a load/store reversed component 260 to perform load and/or store reversed processing, as described herein.

Further, memory 202 is coupled to I/O subsystem 206. I/O subsystem 206 may be a part of the central electronics complex or separate therefrom. It directs the flow of information between main storage 202 and input/output control units 230 and input/output (I/O) devices 240 coupled to the central electronics complex.

Many types of I/O devices may be used. One particular type is a data storage device 250. Data storage device 250 may store one or more programs 252, one or more computer readable program instructions 254, and/or data, etc. The computer readable program instructions may be configured to carry out functions of embodiments of aspects of the invention.

Computer readable program instructions configured to carry out functions of embodiments of aspects of the invention may also or alternatively be included in memory 202. Many variations are possible.

Central electronics complex 200 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with central electronics complex 200. Examples include, but are not limited to: microcode, device drivers, redundant processing units, external disk drive arrays, RAID systems, tape drives, and data archival storage systems, etc.

Further, central electronics complex 200 may be operational with numerous other general-purpose or special purpose computing system environments or configurations. Examples of well-known computing systems, environments, and/or configurations that may be suitable for use with central electronics complex 200 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Although various examples of computing environments are described herein, one or more aspects of the present invention may be used with many types of environments. The computing environments provided herein are only examples.

In accordance with an aspect of the present invention, a computing environment, such as computing environment 100 or central electronics complex 200, executes one or more instructions to perform load and/or store reversed processing. Examples of these instructions include a Vector Load Byte Reversed Elements instruction, a Vector Load Elements Reversed instruction, a Vector Store Byte Reversed Elements instruction and a Vector Store Elements Reversed instruction, each of which is described below. Each instruction has, for instance, a vector register and index storage operation and extended operation code (opcode) field format (VRX).

In one embodiment, these instructions are part of a vector facility; however, in other embodiments, the instructions are not part of the vector facility, but instead, may be part of other facilities. The vector facility provides, for instance, fixed size vectors ranging from one to sixteen elements. Each vector includes data which is operated on by vector operations/instructions, such as the instructions described herein, in accordance with one or more aspects of the present invention. In one embodiment, if a vector is made up of multiple elements, then each element is processed in parallel with the other elements. Instruction completion does not occur until processing of all of the elements is complete, in one example.

Vector data appears in storage, for instance, in the same left-to-right sequence as other data formats. Bits of a data format that are numbered 0-7 constitute the byte in the leftmost (lowest-numbered) byte location in storage, bits 8-15 form the byte in the next sequential location, and so on. In a further example, the vector data may appear in storage in another sequence, such as right-to-left.

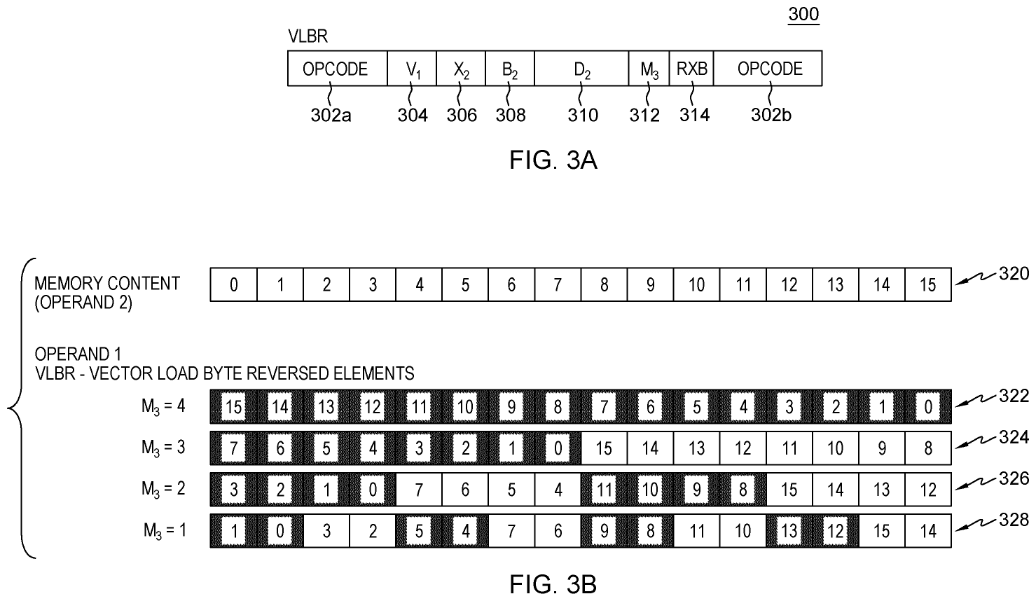

Further details relating to each of the instructions are described below with reference to FIGS. 3A-6B. Each instruction is executed, in one example, using a general-purpose processor (e.g., processor 102 or 204). In the description herein, specific locations, specific fields and/or specific sizes of the fields are indicated (e.g., specific bytes and/or bits). However, other locations, fields and/or sizes may be provided. Further, although various fields and registers are described, one or more aspects of the present invention may use other, additional or fewer fields or registers, or other sizes of fields, registers, etc. Many variations are possible. For instance, implied registers may be used instead of explicitly specified registers or fields of the instruction and/or explicitly specified registers or fields may be used instead of implied registers or fields. Other variations are also possible. Yet, further, although the setting of a bit to a particular value, e.g., one or zero, may be specified, this is only an example. The bit may be set to a different value, such as the opposite value or to another value, in other examples. Again, many variations are possible.

Referring initially to FIG. 3A, a Vector Load Byte Reversed Elements (VLBR) instruction is described. This instruction loads elements of data from memory (or other source location) to another location (e.g., a register or other location) and reverses the data (e.g., bytes) within each element being loaded, as part of execution of the instruction. In one example, a Vector Load Byte Reversed Elements instruction 300 includes a plurality of operation code (opcode) fields 302a, 302b (e.g., bits 0-7 and 40-47) including an operation code specifying a vector load byte reversed elements operation; a vector register field (V₁) 304 (e.g., bits 8-11) indicating a vector register designated operand; an index field (X₂) 306 (e.g., bits 12-15) indicating a general register to be used by the instruction; a base field (B₂) 308 (e.g., bits 16-19) indicating another general register to be used by the instruction; a displacement field (D₂) 310 (e.g., bits 20-31) including a displacement (e.g., a 12-bit unsigned integer) added to the contents of the general registers designated by the X₂ and B₂ fields to form an address of a second operand (in memory) of the instruction; a mask field (M₃) 312 (e.g., bits 32-35) used by the instruction; and a register extension bit (RXB) field 314 (e.g., bits 36-39) used to extend one or more vector register designated operands specified by the instruction (e.g., V₁). Each of the fields 304-314, in one example, is separate and independent from the opcode field(s). Further, in one embodiment, they are separate and independent from one another; however, in other embodiments, more than one field may be combined.

In other embodiments, the addresses of the operands may be determined or obtained in other ways. The memory may be accessed using other registers, immediate fields and/or any other mechanism. Further, in other embodiments, RXB may not be provided and/or used. Other variations are possible.

In one example, the register extension bit or RXB 314, includes the most significant bit for the vector register designated operand (e.g., V₁ in this example). Bits for register designations not specified by the instruction are to be reserved and set to zero.

In one example, the RXB field includes four bits (e.g., bits 0-3), and the bits are defined as follows:

0—Most significant bit for the first vector register designation of the instruction.

1—Most significant bit for the second vector register designation of the instruction, if any.

2—Most significant bit for the third vector register designation of the instruction, if any.

3—Most significant bit for the fourth vector register designation of the instruction, if any.

Each bit is set to zero or one by, for instance, the assembler depending on the register number. For instance, for registers 0-15, the bit is set to 0; for registers 16-31, the bit is set to 1, etc. In one embodiment, each RXB bit is an extension bit for a particular location in an instruction that includes one or more vector registers. For instance, in one or more vector instructions, bit 0 of RXB in an extension bit for location 8-11, which is assigned to e.g., V₁; and so forth. In a further embodiment, the RXB field includes additional bits, and more than one bit is used as an extension for each vector or location.

In one example, the vector (V₁) field, along with its corresponding extension bit specified by RXB, designates a vector register. In particular, for vector registers, the register containing the operand is specified using, for instance, a four-bit field of the register field with the addition of the register extension bit (RXB) as the most significant bit. For instance, if the four-bit field is 0110 and the extension bit is 0, then the five bit field 00110 indicates register number 6.

The M₃ field (e.g., field 312), in one embodiment, specifies the size of the element to be loaded. If a reserved value is specified, a specification exception is recognized, in one example. Example sizes are provided below (other sizes are possible):

| M₃ | Element Size |
|---|---|
| 0 | Reserved |
| 1 | Halfword |
| 2 | Word |
| 3 | Doubleword |
| 4 | Quadword |
| 5-15 | Reserved |

In execution of the Vector Load Byte Reversed Elements instruction, in one example, the second operand (e.g., 16-byte second operand located using, for instance, the second operand address generated using the X₂, B₂ and D₂ fields) is loaded into the first operand location (e.g., the vector register specified using the V₁ and RXB fields). For each element of the second operand (the size of which depends on M₃), the byte order (or other order) is reversed as that element is placed into the corresponding first operand element location. For instance, the leftmost byte of an element becomes the rightmost byte of that element, the second byte from the left becomes the second byte from the right, and so forth.

Example resulting byte positions from executing the instruction, based on the element size, are shown in FIG. 3B. As depicted, operand 2 (320) includes data to be loaded from memory (e.g., 16 bytes of data). If M₃ is equal to 4 (quadword), then the result in operand 1 is as shown at 322; if M₃ is equal to 3 (doubleword), then the result is as shown at 324; if M₃ is equal to 2 (word), then the result is as shown at 326; and if M₃ is equal to 1 (halfword), then the result is as shown at 328.

To further explain, assume in one example M₃=2, then the element size is word (e.g., 4 bytes). Thus, in execution of VLBR, the first element of operand 2 (320) in memory designated by the second operand address (e.g., bytes 0, 1, 2, 3) is placed in the first element of operand 1 (e.g., the vector register designated by V₁ and RXB) and the bytes of the element are reversed in operand 1 (e.g., bytes 3, 2, 1, 0); the second element of operand 2 (e.g., bytes 4, 5, 6, 7) is placed in the second element of operand 1 and the bytes of the element are reversed (e.g., bytes 7, 6, 5, 4); the third element of operand 2 (e.g., bytes 8, 9, 10, 11) is placed in the third element of operand 1 and the bytes of the element are reversed (e.g., bytes 11, 10, 9, 8); and the fourth element of operand 2 (e.g., bytes 12, 13, 14, and 15) is placed in the fourth element of operand 1 and the bytes of the element are reversed (e.g., bytes 15, 14, 13, 12). Similar processing is performed for the other element sizes, which are selectable via the modifier control.

In one example, the condition code resulting from execution of VLBR remains unchanged, and example program exceptions include, for instance: Access (fetch, operand 2); Data with DXC FE, vector instruction; Operation (if the vector enhancements facility 2 for the z/Architecture hardware architecture is not installed); Specification; and Transaction constraint.

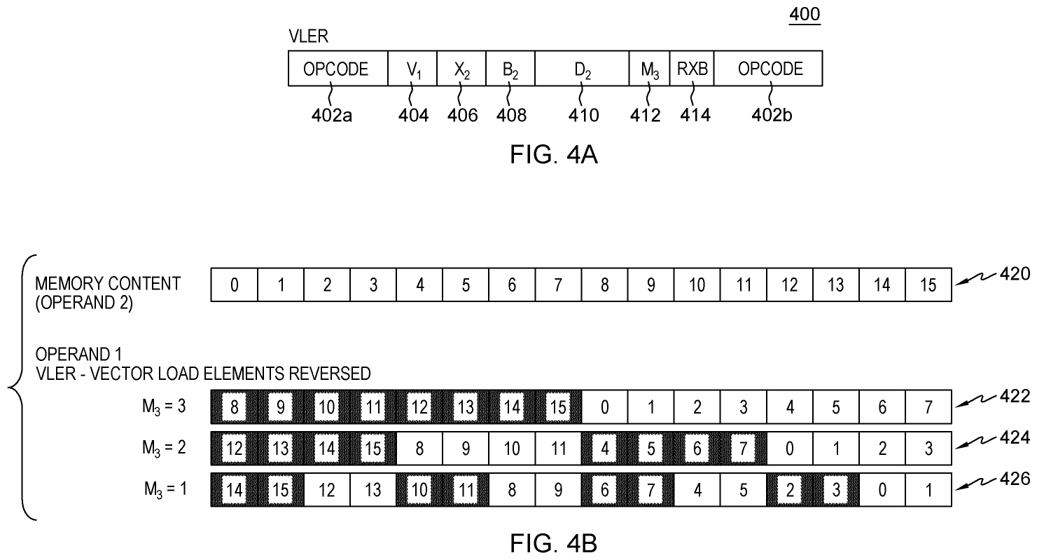

Another instruction to load and reverse data is the Vector Load Elements Reversed (VLER) instruction, an example of which is described with reference to FIG. 4A. This instruction loads elements of data from memory (or other source location) to another location (e.g., a register or other location) and reverses the elements being loaded, as part of execution of the instruction. In one example, a Vector Load Elements Reversed instruction 400 includes a plurality of operation code (opcode) fields 402a, 402b (e.g., bits 0-7 and 40-47) including an operation code specifying a vector load elements reversed operation; a vector register field (V₁) 404 (e.g., bits 8-11) indicating a vector register designated operand; an index field (X₂) 406 (e.g., bits 12-15) indicating a general register to be used by the instruction; a base field (B₂) 408 (e.g., bits 16-19) indicating another general register to be used by the instruction; a displacement field (D₂) 410 (e.g., bits 20-31) including a displacement (e.g., a 12-bit unsigned integer) added to the contents of the general registers designated by the X₂ and B₂ fields to form an address of a second operand (in memory) of the instruction; a mask field (M₃) 412 (e.g., bits 32-35) used by the instruction; and a register extension bit (RXB) field 414 (e.g., bits 36-39) used to extend the vector register designated operand (V₁) specified by the instruction, as described above. Each of the fields 404-414, in one example, is separate and independent from the opcode field(s). Further, in one embodiment, they are separate and independent from one another; however, in other embodiments, more than one field may be combined.

In other embodiments, the addresses of the operands may be determined or obtained in other ways. The memory may be accessed using other registers, immediate fields and/or any other mechanism. Further, in other embodiments, RXB may not be provided and/or used. Other variations are possible.

The M₃ field, in one embodiment, specifies the size of one or more elements to be loaded. If a reserved value is specified, a specification exception is recognized, in one example. Example sizes are provided below:

| M₃ | Element Size |
|---|---|
| 0 | Reserved |
| 1 | Halfword |
| 2 | Word |
| 3 | Doubleword |
| 4-15 | Reserved |

Other sizes are also possible including, but not limited to M₃₌₄ for quadword.

In execution of the Vector Load Elements Reversed instruction, in one example, the second operand (e.g., 16-byte second operand located using, for instance, the second operand address generated using the X₂, B₂ and D₂ fields) is loaded into the first operand location (e.g., the vector register specified using the V₁ and RXB fields). The order of the elements is reversed when loading into the vector register. For instance, element zero in storage becomes the rightmost element in the vector register, element one in storage becomes the second to last element, and so forth. The bytes within the elements themselves are not reversed, in this example.

Example resulting byte positions from executing the instruction, based on the element size, are shown in FIG. 4B. As depicted, operand 2 (420) includes data to be loaded from memory (e.g., 16 bytes of data). If M₃ is equal to 3 (doubleword), then the result is as shown at 422; if M₃ is equal to 2 (word), then the result is as shown at 424; and if M₃ is equal to 1 (halfword), then the result is as shown at 426.

To further explain, assume in one example M₃₌₂, then the element size is word (e.g., 4 bytes). Thus, in execution of VLER, the first element of operand 2 (420) in memory designated by the second operand address (e.g., bytes 0, 1, 2, 3) is placed in operand 1 (e.g., the vector register designated by V₁ and RXB) in the rightmost element of operand 1, thus reversing the elements in the output, but not the bytes within the element; the second element of operand 2 (e.g., bytes 4, 5, 6, 7) is placed in the second to last element of operand 1; the third element of operand 2 (e.g., bytes 8, 9, 10, 11) is placed in the third to last element of operand 1; and the fourth element of operand 2 (e.g., bytes 12, 13, 14, and 15) is placed in the first element of operand 1. Similar processing is performed for the other element sizes, which are selectable via the modifier control.

In one example, the condition code resulting from execution of VLER remains unchanged, and example program exceptions include, for instance: Access (fetch, operand 2); Data with DXC FE, vector instruction; Operation (if the vector enhancements facility 2 for the z/Architecture hardware architecture is not installed); Specification; and Transaction constraint.

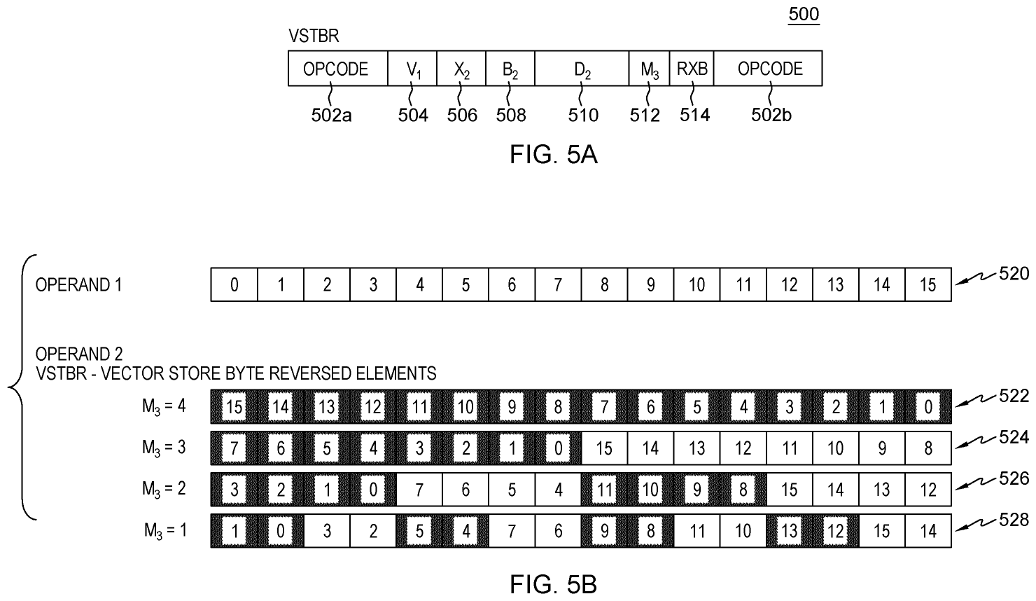

In addition to the load reversed instructions, store reversed instructions are provided, in accordance with an aspect of the present invention. For instance, referring to FIG. 5A, a Vector Store Byte Reversed Elements (VSTBR) instruction is described. This instruction stores elements of data into memory (or other location) from another location (e.g., a register or other location) and reverses the data (e.g., bytes) within each element being stored, as part of execution of the instruction. In one example, a Vector Store Byte Reversed Elements instruction 500 includes a plurality of operation code (opcode) fields 502a, 502b (e.g., bits 0-7 and 40-47) including an operation code specifying a vector store byte reversed elements operation; a vector register field (V₁) 504 (e.g., bits 8-11) indicating a vector register designated operand; an index field (X₂) 506 (e.g., bits 12-15) indicating a general register to be used by the instruction; a base field (B₂) 508 (e.g., bits 16-19) indicating another general register to be used by the instruction; a displacement field (D₂) 510 (e.g., bits 20-31) including a displacement (e.g., a 12-bit unsigned integer) added to the contents of the general registers designated by the X₂ and B₂ fields to form the address of a second operand (in memory) of the instruction; a mask field (M₃) 512 (e.g., bits 32-35) used by the instruction; and a register extension bit (RXB) field 514 (e.g., bits 36-39) used to extend the vector register designated operand (V₁) specified by the instruction, as described above. Each of the fields 504-514, in one example, is separate and independent from the opcode field(s). Further, in one embodiment, they are separate and independent from one another; however, in other embodiments, more than one field may be combined.

In other embodiments, the addresses of the operands may be determined or obtained in other ways. The memory may be accessed using other registers, immediate fields and/or any other mechanism. Further, in other embodiments, RXB may not be provided and/or used. Other variations are possible.

The M₃ field, in one embodiment, specifies the size of the element to be stored. If a reserved value is specified, a specification exception is recognized, in one example. Example sizes are provided below (other sizes are possible):

| M₃ | Element Size |
|---|---|
| 0 | Reserved |
| 1 | Halfword |
| 2 | Word |
| 3 | Doubleword |
| 4 | Quadword |
| 5-15 | Reserved |

In execution of the Vector Store Byte Reversed Elements instruction, in one example, the first operand (e.g., contents of the vector register specified using the V₁ and RXB fields) is stored into the second operand in memory (e.g., 16-byte second operand located using, for instance, the second operand address generated using the X₂, B₂ and D₂ fields). For each element of the first operand, the byte order (or other order) is reversed as that element is placed into the corresponding element of the 16-byte storage. For instance, the leftmost byte of an element becomes the rightmost byte of that element, the second byte from the left becomes the second byte from the right, and so forth.

Example resulting byte positions from executing the instruction, based on the element size, are shown in FIG. 5B. As depicted, operand 1 (520) includes data to be stored into memory (e.g., 16 bytes of data). If M₃ is equal to 4 (quadword), then the result in operand 2 is as shown at 522; if M₃ is equal to 3 (doubleword), then the result is as shown at 524; if M₃ is equal to 2 (word), then the result is as shown at 526; and if M₃ is equal to 1 (halfword), then the result is as shown at 528.

To further explain, assume in one example M₃₌₂, then the element size is word (e.g., 4 bytes). Thus, in execution of VSTBR, the first element of operand 1 (520) in, e.g., the vector register designated by V₁ and RXB (e.g., bytes 0, 1, 2, 3) is placed in the first element of operand 2 (e.g., in memory starting at the second operand address) and the bytes of the element are reversed in operand 2 (e.g., bytes 3, 2, 1, 0); the second element of operand 1 (e.g., bytes 4, 5, 6, 7) is placed in the second element of operand 2 and the bytes of the element are reversed (e.g., bytes 7, 6, 5, 4); the third element of operand 1 (e.g., bytes 8, 9, 10, 11) is placed in the third element of operand 2 and the bytes of the element are reversed (e.g., bytes 11, 10, 9, 8); and the fourth element of operand 1 (e.g., bytes 12, 13, 14, and 15) is placed in the fourth element of operand 2 and the bytes of the element are reversed (e.g., bytes 15, 14, 13, 12). Similar processing is performed for the other element sizes, which are selectable via the modifier control.

In one example, the condition code resulting from execution of VSTBR remains unchanged, and example program exceptions include, for instance: Access (fetch, operand 2); Data with DXC FE, vector instruction; Operation (if the vector enhancements facility 2 for the z/Architecture hardware architecture is not installed); Specification; and Transaction constraint.

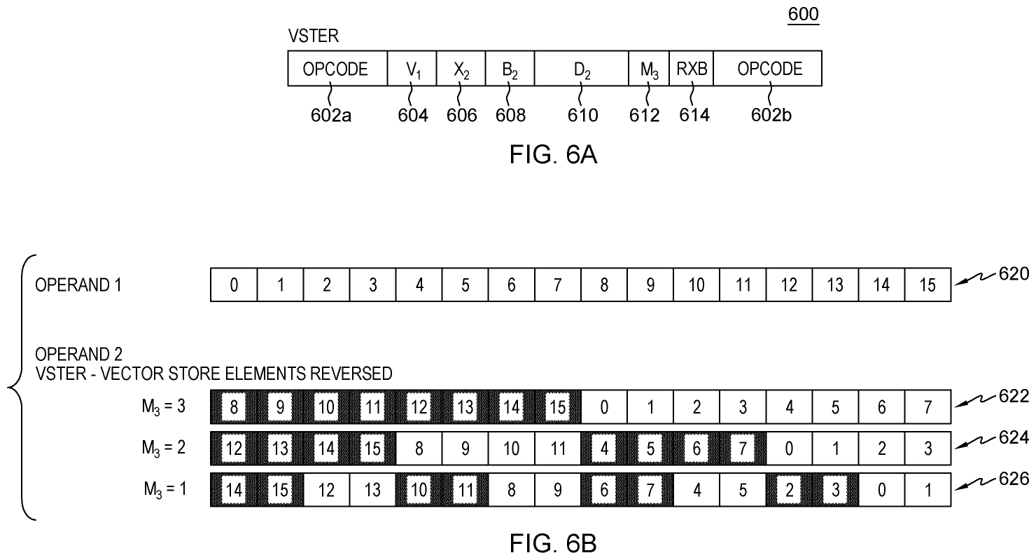

Another store instruction to reverse data is the Vector Store Elements Reversed (VSTER) instruction, an example of which is described with reference to FIG. 6A. This instruction stores elements of data into memory (or other location) from another location (e.g., a register or other location) and reverses the elements being stored, as part of execution of the instruction. In one example, a Vector Store Elements Reversed instruction 600 includes a plurality of operation code (opcode) fields 602a, 602b (e.g., bits 0-7 and 40-47) including an operation code specifying a vector store elements reversed operation; a vector register field (V₁) 604 (e.g., bits 8-11) indicating a vector register designated operand; an index field (X₂) 606 (e.g., bits 12-15) indicating a general register to be used by the instruction; a base field (B₂) 608 (e.g., bits 16-19) indicating another general register to be used by the instruction; a displacement field (D₂) 610 (e.g., bits 20-31) including a displacement (e.g., a 12-bit unsigned integer) added to the contents of the general registers designated by the X₂ and B₂ fields to form the address of a second operand (in memory) of the instruction; a mask field (M₃) 612 (e.g., bits 32-35) used by the instruction; and a register extension bit (RXB) field 614 (e.g., bits 36-39) used to extend the vector register designated operand (V₁) specified by the instruction, as described above. Each of the fields 604-614, in one example, is separate and independent from the opcode field(s). Further, in one embodiment, they are separate and independent from one another; however, in other embodiments, more than one field may be combined.

In other embodiments, the addresses of the operands may be determined or obtained in other ways. The memory may be accessed using other registers, immediate fields and/or any other mechanism. Further, in other embodiments, RXB may not be provided and/or used. Other variations are possible.

The M₃ field, in one embodiment, specifies the size of the element to be stored. If a reserved value is specified, a specification exception is recognized, in one example. Example sizes are provided below:

| M₃ | Element Size |
|---|---|
| 0 | Reserved |
| 1 | Halfword |
| 2 | Word |
| 3 | Doubleword |
| 4-15 | Reserved |

Other sizes are also possible including, but not limited to M₃=4 for quadword.

In execution of the Vector Store Elements Reversed instruction, in one example, the first operand (e.g., contents of the vector register specified using the V₁ and RXB fields) is stored into the second operand in memory (e.g., 16-byte second operand located using, for instance, the second operand address generated using the X₂, B₂ and D₂ fields). The order of the elements is reversed when storing into the storage location. For instance, the rightmost element in the vector register becomes element zero in storage, the second to last element becomes element one in storage, and so forth. The bytes within the elements themselves are not reversed, in this example.

Example resulting byte positions from executing the instruction, based on the element size, are shown in FIG. 6B. As depicted, operand 1 (620) includes data to be stored into memory (e.g., 16 bytes of data). If M₃ is equal to 3 (doubleword), then the result is as shown at 622; if M₃ is equal to 2 (word), then the result is as shown at 624; and if M₃ is equal to 1 (halfword), then the result is as shown at 626.

To further explain, assume in one example M₃=2, then the element size is word (e.g., 4 bytes). Thus, in execution of VSTER, the first element of operand 1 (620) in, e.g., the vector register designated by V₁ and RXB (e.g., bytes 0, 1, 2, 3) is placed in operand 2 (e.g., in memory located using the second operand address) in the rightmost element of operand 2, thus reversing the elements in the output, but not the bytes within the element; the second element of operand 1 (e.g., bytes 4, 5, 6, 7) is placed in the second to last element of operand 2; the third element of operand 1 (e.g., bytes 8, 9, 10, 11) is placed in the third to last element of operand 2; and the fourth element of operand 1 (e.g., bytes 12, 13, 14, and 15) is placed in the first element of operand 2. Similar processing is performed for the other element sizes, which are selectable via the modifier control.

In one example, the condition code resulting from execution of VSTER remains unchanged, and example program exceptions include, for instance: Access (fetch, operand 2); Data with DXC FE, vector instruction; Operation (if the vector enhancements facility 2 for the z/Architecture hardware architecture is not installed); Specification; and Transaction constraint.

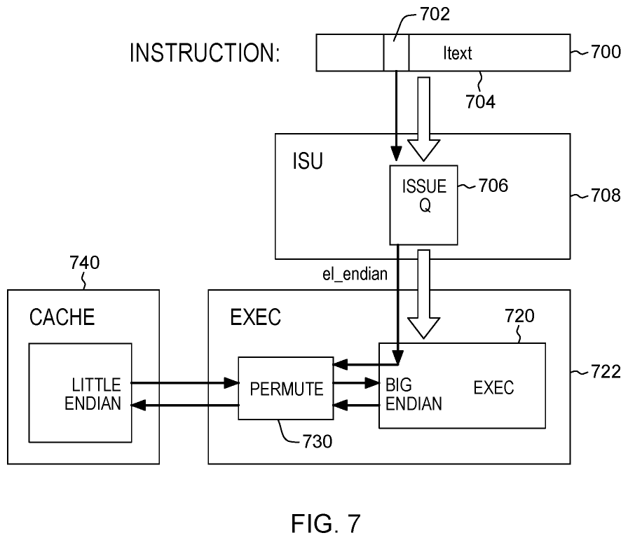

Further details relating to execution of the load and store reversed instructions are described with reference to FIGS. 7-9. In this example, the instructions are discussed with reference to converting between the little-endian format and the big-endian format. However, the instructions described herein can be used for other purposes.

Referring initially to FIG. 7, in one embodiment, an instruction 700, such as a Vector Load Byte Reversed Elements instruction, a Vector Load Elements Reversed instruction, a Vector Store Byte Reversed Elements instruction or a Vector Store Elements Reversed instruction, includes a plurality of fields, including a modifier control field 702 (e.g., an M₃ field, such as M₃ field 312, 412, 512 or 612) and one or more fields 704 that include instruction text (Itext). The instruction text includes, for instance, fields used by the instruction, including, for instance, one or more opcode fields (e.g., opcode fields 302a, 302b; 402a, 402b; 502a, 502b; or 602a, 602b), a vector register field (e.g., V₁ 304, V₁ 404, V₁ 504, or V₁ 604), an index field (e.g., X₂ 306, X₂ 406, X₂ 506, or X₂ 606), a base field (e.g., B₂ 308, B₂ 408, B₂ 508, or B₂ 608), a displacement field (e.g., D₂ 310, D₂ 410, D₂ 510, or D₂ 610) and/or a register bit extension field (e.g., RXB 314, RXB 414, RXB 514, or RXB 614). Additional, fewer and/or other fields may be included in Itext 704. Field 702 may be included, in one example, as part of the instruction text. Other variations are also possible.

In another embodiment, the modifier control (e.g., M₃) is not in an explicit field of the instruction, but instead, is included in an implied field or register of the instruction. Further, in another embodiment, the modifier control is not part of the instruction itself, but in a location (e.g., a register or memory location) accessible to the instruction, or part of another instruction (e.g., a prefix instruction) used to modify the instruction to be executed. Other variations are possible.

Continuing with FIG. 7, the instruction (e.g., instruction 700) is dispatched to an issue queue 706 of an instruction sequencing unit (ISU) 708 of the processor where it may wait until, for instance, its operands are available (e.g., first operand, second operand). When ready, the instruction is issued to an appropriate functional execution unit 720 of an execution unit 722 of the processor. As an example, since the instruction is a vector instruction, it is issued to a vector unit that performs vector computations. Other examples are possible.

Execution unit 720 receives the instruction to execute, as well as the modifier control 702 (also referred to as an M₃ bit or el_endian). Execution unit 720 is defined to process data in a big-endian format. Therefore, if data is in a little-endian format or is to be converted back to a little-endian format, the data is permuted, using, for instance, a permute component 730 (e.g., a hardware component). For instance, if the received instruction indicates that data is to be permuted (e.g., based on the opcode, such as opcode 302a, 302b; 402a, 402b; 502a, 502b; or 602a, 602b), permute component 730 is used to permute the data based on the opcode and modifier control, as described herein.

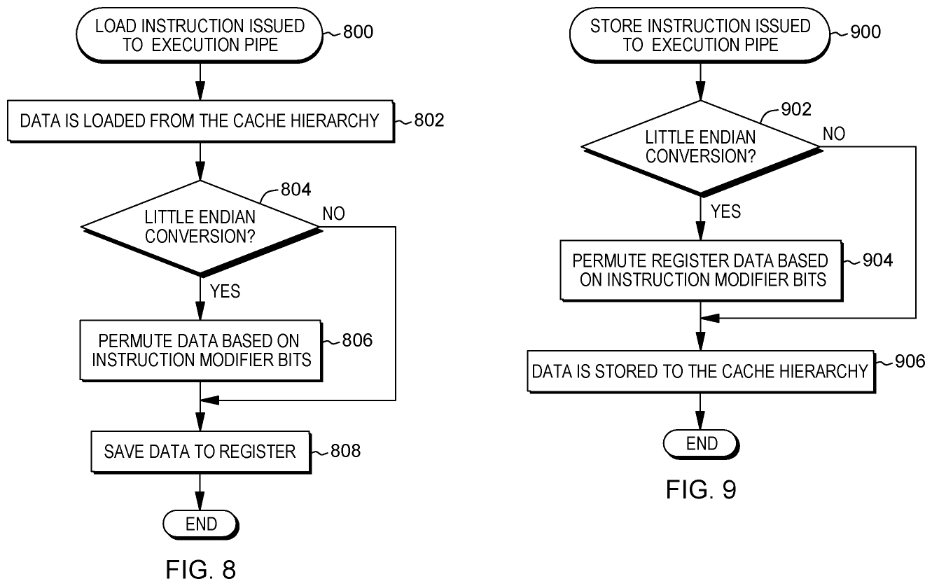

For instance, if the opcode indicates a load reversed instruction (either load byte reversed elements or load elements reversed), permute component 730 obtains the data to be loaded from memory (e.g., data in the little-endian format from cache 740), as well as the modifier control (e.g., el_endian—indicating the element size) and the particular operation to be performed (e.g., load byte reversed elements or load elements reversed), and permutes the data, saving the permuted data (e.g., in big-endian format) to a selected location, such as a register. This is described further with reference to FIG. 8.

In one example, referring to FIG. 8, a load instruction is issued to an execution unit of the processor (e.g., execution unit 722), STEP 800. The execution unit of the processor begins executing the instruction, and data is loaded from cache hierarchy 740 (using, e.g., the second operand address), STEP 802. A determination is made as to whether little endian conversion is to be performed, INQUIRY 804. In one example, this is based on the opcode of the instruction, which indicates whether this is a load and data reverse instruction. If conversion is to be performed, then in accordance with an aspect of the present invention, permute component 730 is used to permute the data based on the element size and the type of conversion to be performed (e.g., load byte reversed elements or load elements reversed, based on the opcode), STEP 806. Thereafter or if little endian conversion is not to be performed, the data (either original format or permuted) is saved to a register (e.g., as specified by V₁ and RXB), STEP 808. In one example, the data in memory is in the little-endian format, and the permuted data stored to the register is in the big-endian format. This is only one example. In other examples, the data in memory is in the big-endian format and the permuted data is in the little-endian format. Other variations are possible.

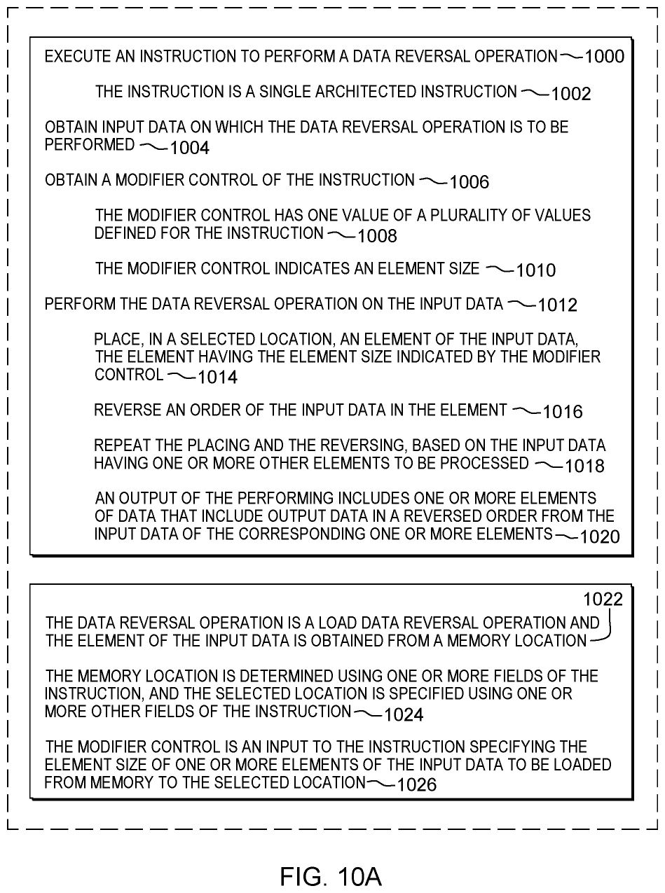

Similarly, returning to FIG. 7, if the opcode of the instruction to be executed indicates a store reversed instruction (either store byte reversed elements or store elements reversed), permute component 730 obtains the data (e.g., in big-endian format) to be stored into memory from a selected location (e.g., first operand), as well as the modifier control (e.g., el_endian—indicating the element size) and the particular operation to be performed (e.g., store byte reversed elements or store elements reversed), and permutes the data, saving the permuted data (e.g., in little-endian format) to memory, such as cache 740. This is described further with reference to FIG. 9.

In one example, referring to FIG. 9, a store instruction is issued to an execution unit of the processor (e.g., execution unit 722), STEP 900. The execution unit of the processor begins executing the instruction, which includes determining whether little endian conversion is to be performed, INQUIRY 902. In one example, this is based on the opcode of the instruction, which indicates whether this is a store and data reverse instruction. If conversion is to be performed, then in accordance with an aspect of the present invention, permute component 730 is used to permute the data in the register specified by, e.g., V₁ and RXB of the instruction, based on the element size and the particular operation to be performed (e.g., store byte reversed elements or store elements reversed), STEP 904. Thereafter or if little endian conversion is not to be performed, the data (either original format or permuted) is stored to cache hierarchy 740 (using, e.g., the second operand address), STEP 906. In one example, the data in the register is in the big-endian format, and the permuted data stored to the cache is in the little-endian format. This is only one example. In other examples, the data in the register is in the little-endian format and the permuted data is in the big-endian format. Other variations are possible.

Described above are load and store instructions that can also permute the data while performing the load or the store operation. By using a single architected instruction to perform the load or store operation and to permute the data, processing is facilitated, and performance is enhanced. By using one instruction to perform the load/store and permute, instead of separate instructions to perform the load/store and permute (one instruction to perform the load/store and one instruction to perform the permute), execution time is decreased, and performance is enhanced, facilitating processing within the computer itself, as well as tasks using those operations.

Although various embodiments are shown and described, other variations are possible. For instance, an instruction may be used that reverses the elements, as well as the bytes within the reversed elements. Other variations are possible. Further, although in one example, bytes within the elements are being reversed, in other examples, data units of other sizes may be reversed. Yet further, units other than elements may be reversed. Many variations are possible.

One or more aspects of the present invention are inextricably tied to computer technology and facilitate processing within a computer, improving performance thereof. Processing is facilitated by, for instance, using the load or store reverse instructions to switch endianness. This facilitates processing when a processor is operating in a different endian format. By facilitating processing, performance is improved, as well as tasks or operations that are to use various endian formats.

The instructions may be used, for instance, in machine learning, in which a model developed for one endian format is to be used on machines with another endian format. This provides compatibility among processors of different endianness, improving processing and performance. Many possibilities exist.

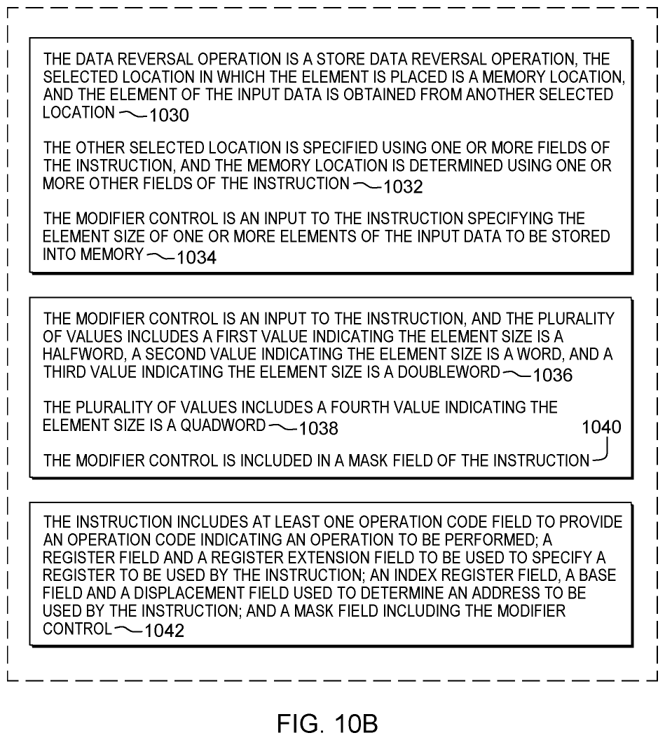

Further details of one embodiment of facilitating processing within a computing environment, as it relates to one or more aspects of the present invention, are described with reference to FIGS. 10A-10B.

Referring to FIG. 10A, in one embodiment, an instruction to perform a data reversal operation is executed (1000) by, e.g., hardware of a processor (e.g., processor 102 or 204). The hardware may be within the processor or coupled thereto for purposes of receiving the instruction from the processor, which, e.g., obtains, decodes and sets-up the instruction to execute on the hardware. Other variations are possible. The instruction is, for instance, a single architected instruction (1002).

The executing includes obtaining input data on which the data reversal operation is to be performed (1004) and obtaining a modifier control of the instruction (1006). The modifier control has one value of a plurality of values defined for the instruction (1008) and indicates an element size (1010). The data reversal operation is performed on the input data (1012). The performing includes placing, in a selected location, an element of the input data, the element having the element size indicated by the modifier control (1014); reversing an order of the input data in the element (1016); and repeating the placing and the reversing, based on the input data having one or more other elements to be processed (1018). An output of the performing includes one or more elements of data that include output data in a reversed order from the input data of the corresponding one or more elements (1020).

By using a single architected instruction having a selectable element size, processing within the computing environment is facilitated. The number of instructions to be defined and implemented is reduced, as well as complexity of the architecture. Memory is also saved.

In one embodiment, the data reversal operation is a load data reversal operation and the element of the input data is obtained from a memory location (1022). The memory location is determined, for instance, using one or more fields of the instruction, and the selected location is specified using one or more other fields of the instruction (1024). As an example, the modifier control is an input to the instruction specifying the element size of one or more elements of the input data to be loaded from memory to the selected location (1026). Based on the load data reversal operation, the bytes within the elements being loaded are reversed.

By using a single architected instruction to perform the load operation and the data reversal operation, instead of separate instructions to perform the two operations, execution time is decreased, and performance is improved.

In another embodiment, referring to FIG. 10B, the data reversal operation is a store data reversal operation, the selected location in which the element is placed is a memory location, and the element of the input data is obtained from another selected location (1030). The other selected location is specified, for instance, using one or more fields of the instruction, and the memory location is determined using one or more other fields of the instruction (1032). As an example, the modifier control is an input to the instruction specifying the element size of one or more elements of the input data to be stored into memory (1034). Based on the store data reversal operation, the bytes within the elements being stored are reversed.

By using a single architected instruction to perform the store operation and the data reversal operation, instead of separate instructions to perform the two operations, execution time is decreased, and performance is improved.

In one example, the modifier control is an input to the instruction, and the plurality of values includes a first value indicating the element size is a halfword, a second value indicating the element size is a word, and a third value indicating the element size is a doubleword (1036). In a further example, the plurality of values includes a fourth value indicating the element size is a quadword (1038). As a particular example, the modifier control is included in a mask field of the instruction (1040).

As an example, the instruction includes at least one operation code field to provide an operation code indicating an operation to be performed; a register field and a register extension field to be used to specify a register to be used by the instruction; an index register field, a base field and a displacement field used to determine an address to be used by the instruction; and a mask field including the modifier control (1042).

Other variations and embodiments are possible.

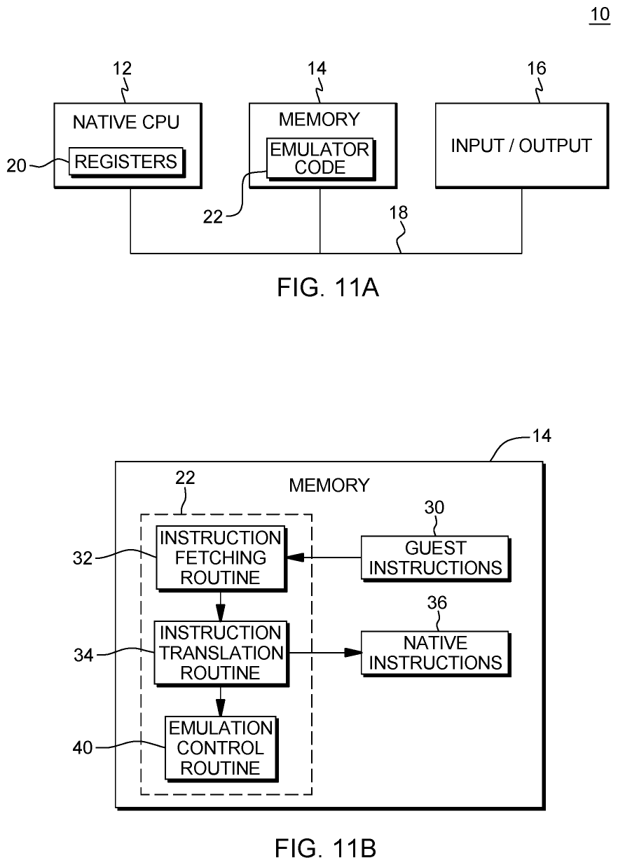

Aspects of the present invention may be used by many types of computing environments. Another embodiment of a computing environment to incorporate and use one or more aspects of the present invention is described with reference to FIG. 11A. In this example, a computing environment 10 includes, for instance, a native central processing unit (CPU) 12, a memory 14, and one or more input/output devices and/or interfaces 16 coupled to one another via, for example, one or more buses 18 and/or other connections. As examples, computing environment 10 may include a PowerPC® processor offered by International Business Machines Corporation, Armonk, N.Y.; an HP Superdome with Intel Itanium II processors offered by Hewlett Packard Co., Palo Alto, Calif.; and/or other machines based on architectures offered by International Business Machines Corporation, Hewlett Packard, Intel Corporation, Oracle, or others. IBM, z/Architecture, IBM Z, z/OS, PR/SM and PowerPC are trademarks or registered trademarks of International Business Machines Corporation in at least one jurisdiction. Intel and Itanium are trademarks or registered trademarks of Intel Corporation or its subsidiaries in the United States and other countries.

Native central processing unit 12 includes one or more native registers 20, such as one or more general purpose registers and/or one or more special purpose registers used during processing within the environment. These registers include information that represents the state of the environment at any particular point in time.

Moreover, native central processing unit 12 executes instructions and code that are stored in memory 14. In one particular example, the central processing unit executes emulator code 22 stored in memory 14. This code enables the computing environment configured in one architecture to emulate another architecture. For instance, emulator code 22 allows machines based on architectures other than the z/Architecture hardware architecture, such as PowerPC processors, HP Superdome servers or others, to emulate the z/Architecture hardware architecture and to execute software and instructions developed based on the z/Architecture hardware architecture.

Further details relating to emulator code 22 are described with reference to FIG. 11B. Guest instructions 30 stored in memory 14 comprise software instructions (e.g., correlating to machine instructions) that were developed to be executed in an architecture other than that of native CPU 12. For example, guest instructions 30 may have been designed to execute on a processor based on the z/Architecture hardware architecture, but instead, are being emulated on native CPU 12, which may be, for example, an Intel Itanium II processor. In one example, emulator code 22 includes an instruction fetching routine 32 to obtain one or more guest instructions 30 from memory 14, and to optionally provide local buffering for the instructions obtained. It also includes an instruction translation routine 34 to determine the type of guest instruction that has been obtained and to translate the guest instruction into one or more corresponding native instructions 36. This translation includes, for instance, identifying the function to be performed by the guest instruction and choosing the native instruction(s) to perform that function.

Further, emulator code 22 includes an emulation control routine 40 to cause the native instructions to be executed. Emulation control routine 40 may cause native CPU 12 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 36 may include loading data into a register from memory 14; storing data back to memory from a register; or performing some type of arithmetic or logic operation, as determined by the translation routine.

Each routine is, for instance, implemented in software, which is stored in memory and executed by native central processing unit 12. In other examples, one or more of the routines or operations are implemented in firmware, hardware, software or some combination thereof. The registers of the emulated processor may be emulated using registers 20 of the native CPU or by using locations in memory 14. In embodiments, guest instructions 30, native instructions 36 and emulator code 22 may reside in the same memory or may be disbursed among different memory devices.

The computing environments described above are only examples of computing environments that can be used. Other environments, including but not limited to, non-partitioned environments, partitioned environments, and/or emulated environments, may be used; embodiments are not limited to any one environment.

Each computing environment is capable of being configured to include one or more aspects of the present invention. For instance, each may be configured to provide load/store reversed processing, in accordance with one or more aspects of the present invention.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

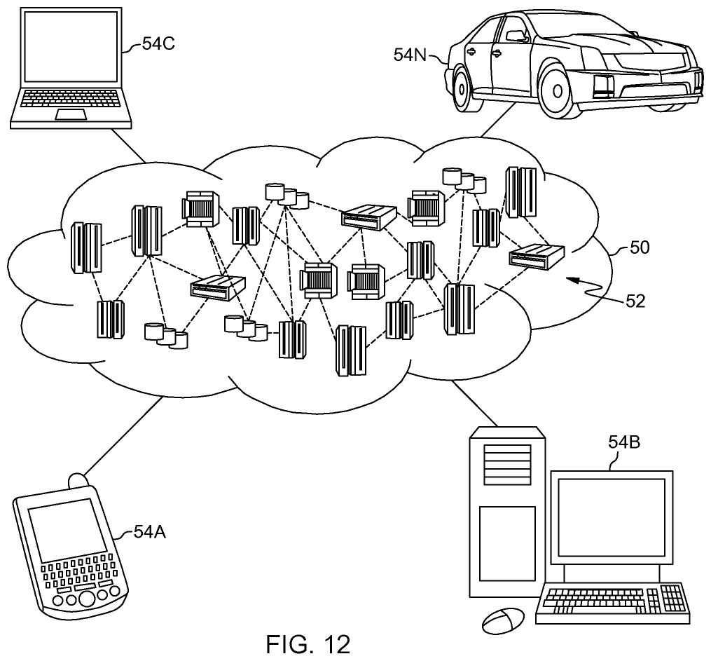

Referring now to FIG. 12, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 52 and cloud computing environment 50 can communicate with any type of computerized device over any type of network and/or network addressable connection (e.g., using a web browser).

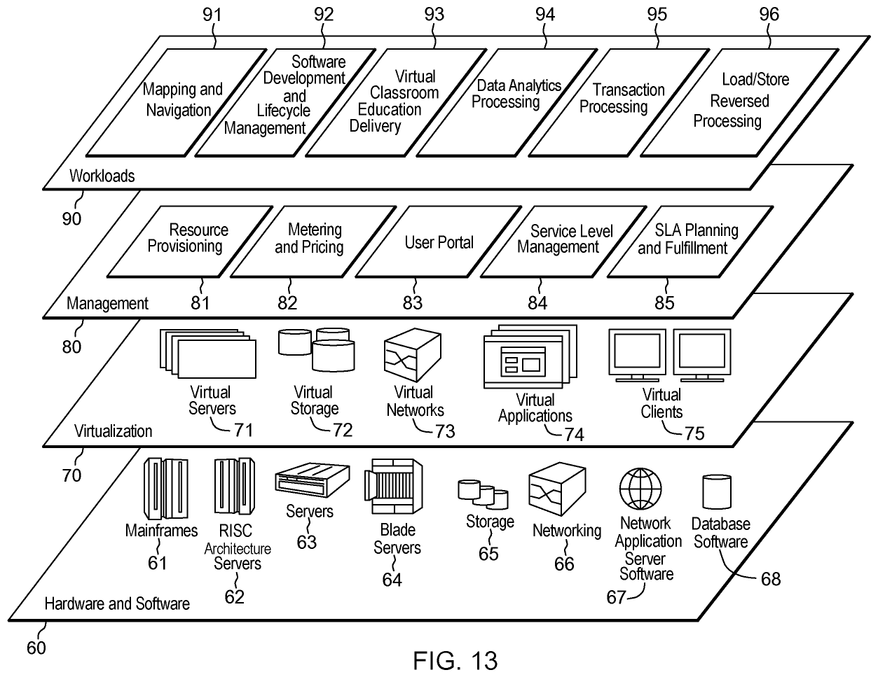

Referring now to FIG. 13, a set of functional abstraction layers provided by cloud computing environment 50 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and load/store reversed processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, computing environments of other architectures can be used to incorporate and use one or more embodiments. Further, different instructions or operations may be used. Additionally, different types of indicators may be specified. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
a computer readable storage medium readable by a processing circuit and storing instructions for performing a method comprising:
executing an instruction to perform a data reversal operation, the instruction being a single architected instruction, and the executing including:
obtaining input data on which the data reversal operation is to be performed;
obtaining a modifier control of the instruction, the modifier control having one value of a plurality of values defined for the instruction, the modifier control indicating an element size; and
performing the data reversal operation on the input data, wherein the performing comprising:
placing, in a selected location, an element of the input data, the element having the element size indicated by the modifier control;
reversing an order of the input data in the element; and
repeating the placing and the reversing, based on the input data having one or more other elements to be processed, wherein an output of the performing includes one or more elements of data that include output data in a reversed order from the input data of the corresponding one or more elements.

2. The computer program product of claim 1, wherein the data reversal operation is a load data reversal operation and the element of the input data is obtained from a memory location.

3. The computer program product of claim 2, wherein the memory location is determined using one or more fields of the instruction, and the selected location is specified using one or more other fields of the instruction.

4. The computer program product of claim 2, wherein the modifier control is an input to the instruction specifying the element size of one or more elements of the input data to be loaded from memory to the selected location.

5. The computer program product of claim 1, wherein the data reversal operation is a store data reversal operation, the selected location in which the element is placed is a memory location, and the element of the input data is obtained from another selected location.

6. The computer program product of claim 5, wherein the other selected location is specified using one or more fields of the instruction, and the memory location is determined using one or more other fields of the instruction.

7. The computer program product of claim 5, wherein the modifier control is an input to the instruction specifying the element size of one or more elements of the input data to be stored into memory.

8. The computer program product of claim 1, wherein the modifier control is an input to the instruction, and wherein the plurality of values comprises a first value indicating the element size is a halfword, a second value indicating the element size is a word, and a third value indicating the element size is a doubleword.

9. The computer program product of claim 1, wherein the modifier control is an input to the instruction, and wherein the plurality of values comprises a fourth value indicating the element size is a quadword.

10. The computer program product of claim 1, wherein the modifier control is included in a mask field of the instruction.

11. The computer program product of claim 1, wherein the instruction includes at least one operation code field to provide an operation code indicating an operation to be performed; a register field and a register extension field to be used to specify a register to be used by the instruction; an index register field, a base field and a displacement field used to determine an address to be used by the instruction; and a mask field including the modifier control.

12. A computer system for facilitating processing within a computing environment, the computer system comprising:
a memory; and
a processor coupled to the memory, wherein the computer system is configured to perform a method comprising:
executing an instruction to perform a data reversal operation, the instruction being a single architected instruction, and the executing including:
obtaining input data on which the data reversal operation is to be performed;
obtaining a modifier control of the instruction, the modifier control having one value of a plurality of values defined for the instruction, the modifier control indicating an element size; and
performing the data reversal operation on the input data, wherein the performing comprising:
placing, in a selected location, an element of the input data, the element having the element size indicated by the modifier control;
reversing an order of the input data in the element; and
repeating the placing and the reversing, based on the input data having one or more other elements to be processed, wherein an output of the performing includes one or more elements of data that include output data in a reversed order from the input data of the corresponding one or more elements.

13. The computer system of claim 12, wherein the data reversal operation is a load data reversal operation and the element of the input data is obtained from a memory location.

14. The computer system of claim 12, wherein the data reversal operation is a store data reversal operation, the selected location in which the element is placed is a memory location, and the element of the input data is obtained from another selected location.

15. The computer system of claim 12, wherein the modifier control is an input to the instruction, and wherein the plurality of values comprises a first value indicating the element size is a halfword, a second value indicating the element size is a word, a third value indicating the element size is a doubleword, and a fourth value indicating the element size is a quadword.

16. The computer system of claim 12, wherein the modifier control is included in a mask field of the instruction.

17. A computer-implemented method of facilitating processing within a computing environment, the computer-implemented method comprising:
executing an instruction to perform a data reversal operation, the instruction being a single architected instruction, and the executing including:
obtaining input data on which the data reversal operation is to be performed;
obtaining a modifier control of the instruction, the modifier control having one value of a plurality of values defined for the instruction, the modifier control indicating an element size; and
performing the data reversal operation on the input data, wherein the performing comprising:
placing, in a selected location, an element of the input data, the element having the element size indicated by the modifier control;
reversing an order of the input data in the element; and
repeating the placing and the reversing, based on the input data having one or more other elements to be processed, wherein an output of the performing includes one or more elements of data that include output data in a reversed order from the input data of the corresponding one or more elements.

18. The computer-implemented method of claim 17, wherein the data reversal operation is a load data reversal operation and the element of the input data is obtained from a memory location.

19. The computer-implemented method of claim 17, wherein the data reversal operation is a store data reversal operation, the selected location in which the element is placed is a memory location, and the element of the input data is obtained from another selected location.

20. The computer-implemented method of claim 17, wherein the modifier control is included in a mask field of the instruction.
